(19) United States
(12) Patent Application Publication
(10) Pub. No.: US 2016/0313233 A1
(43) Pub. Date: Oct. 27, 2016

(54) PHOTOACOUSTIC SPECTROMETER FOR NONDESTRUCTIVE AEROSOL ABSORPTION SPECTROSCOPY

(71) Applicant: NATIONAL INSTITUTE OF STANDARDS AND TECHNOLOGY, Gaithersburg, MD (US)

(72) Inventors: CHRISTOPHER D. ZANGMEISTER, GAITHERSBURG, MD (US); JAMES G. RADNEY, SILVER SPRING, MD (US)

(21) Appl. No.: 15/078,589

(22) Filed: Mar. 23, 2016

Related U.S. Application Data
(60) Provisional application No. 62/151,499, filed on Apr. 23, 2015.

(51) Int. Cl. G01N 21/17; G01N 21/25; G01N 21/31

(52) U.S. Cl. CPC G01N 21/1702; G01N 21/31; G01N 21/255; G01N 2021/1704; G01N 2201/068; G01N 2201/06113

(57) ABSTRACT

A photoacoustic spectrometer includes: a light source including: a supercontinuum laser to produce a first light including a high-frequency; a tunable wavelength filter to select a wavelength of the first light; a bandwidth filter to select a bandwidth of the first light; a modulator to receive the first light and to modulate the first light at an acoustic frequency to produce a probe light including: the acoustic frequency; and the high-frequency, the light source to irradiate nondestructively a sample with the probe light; a cavity to receive the sample and the probe light and including: a first window to transmit the probe light into the cavity; and a second window to transmit the probe light out of the cavity; a transducer to detect a photoacoustic signal produced from the sample in response to absorption of the probe light by the sample; and an optical detector to detect the probe light.

### CROSS REFERENCE TO RELATED APPLICATIONS

This application claims the benefit of U.S. Provisional Patent Application Ser. No. 62/151,499, filed Apr. 23, 2015, the disclosure of which is incorporated herein by reference in its entirety.

### STATEMENT REGARDING FEDERALLY SPONSORED RESEARCH

This invention was made with United States Government support from the National Institute of Standards and Technology. The Government has certain rights in the invention.

### BRIEF DESCRIPTION

Disclosed is a photoacoustic spectrometer comprising: a light source to irradiate nondestructively a sample and to provide a probe light comprising: an acoustic frequency; and a high frequency; and a transducer to detect a photoacoustic signal, the photoacoustic signal produced from the sample in response to absorption of the probe light by the sample.

Further disclosed is a photoacoustic spectrometer comprising: a light source comprising: a supercontinuum laser to produce a first light comprising a high-frequency; a tunable wavelength filter to select a wavelength of the first light; a bandwidth filter to select a bandwidth of the first light; a modulator to receive the first light and to modulate the first light at an acoustic frequency to produce a probe light comprising: the acoustic frequency; and the high-frequency, the light source to irradiate nondestructively a sample with the probe light; a cavity to receive the sample and the probe light and comprising: a first window to transmit the probe light into the cavity; and a second window to transmit the probe light out of the cavity; a transducer to detect a photoacoustic signal produced from the sample in response to absorption of the probe light by the sample; and an optical detector to detect the probe light.

Additionally disclosed is a process for performing photoacoustic spectroscopy, the process comprising: producing a first light comprising a high-frequency; modulating the first light at an acoustic frequency to produce a probe light comprising: the acoustic frequency; and the high-frequency; communicating the probe light to a cavity; providing a sample to the cavity; irradiating nondestructively the sample with the probe light; producing a photoacoustic signal by the sample in response to absorption of the probe light by the sample; and detecting the photoacoustic signal to perform photoacoustic spectroscopy on the sample.

### BRIEF DESCRIPTION OF THE DRAWINGS

The following descriptions should not be considered limiting in any way. With reference to the accompanying drawings, like elements are numbered alike.

FIG. 1 shows a photoacoustic spectrometer;

FIG. 2 shows a photoacoustic spectrometer;

FIG. 3 shows a photoacoustic spectrometer;

FIG. 4 shows a photoacoustic spectrometer;

FIG. 5 shows a photoacoustic spectrometer;

FIG. 6 shows a photoacoustic spectrometer;

FIG. 7 shows a photoacoustic spectrometer and a plurality of waveforms;

FIG. 8 shows events in performing photoacoustic spectroscopy on a sample;

FIG. 9 shows a waveform of a first light;

FIG. 10 shows a modulation waveform;

FIG. 11 shows an overlap of the waveform of the first light shown in FIG. 9 and the modulation waveform shown in FIG. 10;

FIG. 12 shows a waveform of a probe light;

FIG. 13 shows a waveform of a first light;

FIG. 14 shows a modulation waveform;

FIG. 15 shows a waveform of a probe light;

FIG. 16 shows a graph of amplitude versus frequency;

FIG. 17 shows a flowchart of a process for performing photoacoustic spectroscopy on a sample;

FIG. 18 shows a graph of absorption cross-section (C_{abs}) versus relative humidity (RH);

FIG. 19 shows an experimental setup for spectral absorption measurements according to Example 5;

FIG. 20 shows a photoacoustic spectrometer according to Example 5;

FIG. 21 shows a graph of absorption cross-section (a_{abs}) versus wavelength;

FIG. 22 shows a graph of MAC versus wavelength;

FIG. 23 shows a graph of absorption cross-section (a_{abs}) versus wavelength;

FIG. 24 shows a graph of absorption cross-section (a_{abs}) versus wavelength; and

FIG. 25 shows a graph of absorption coefficient versus wavelength.

### DETAILED DESCRIPTION

A detailed description of one or more embodiments is presented herein by way of exemplification and not limitation.

It has been discovered that a photoacoustic (PA) spectrometer herein provides acquisition of absorption spectra of a sample such as an aerosol, wherein particles of the aerosol are not destroyed when irradiated by a probe light of the photoacoustic spectrometer. A light source provides the probe light in the photoacoustic spectrometer to provide a quantitative absorption measurement of particles in the sample. The particles can include a volatile or semi-volatile coating. The photoacoustic spectrometer and a process herein decrease uncertainty in an aerosol absorption measurement.

In the photoacoustic spectrometer, particles in a sample absorb probe light and transform the absorbed probe light into heat or a pressure wave (e.g., an acoustic sound wave), referred to herein as a photoacoustic signal. The photoacoustic signal is detected by a transducer. The transducer produces a spectrometer signal in response to receiving the photoacoustic signal. The spectrometer signal is measured, and absorption by the sample is determined from the spectrometer signal.

According to an embodiment, the photoacoustic spectrometer subjects the sample to the probe light, wherein particles in the sample nondestructively absorb the probe light and emit the photoacoustic signal. In some embodiments, a high frequency (repetition rate) and short pulse width light source is included in the photoacoustic spectrometer to measure an absorption of the sample. In a presence of the short pulses (e.g., picoseconds such as 1×10⁻¹² seconds) of the probe light, particles in the sample absorb energy from the probe light and transfer the energy as heat to the surrounding medium at a faster rate than a vaporization of the particles can occur.

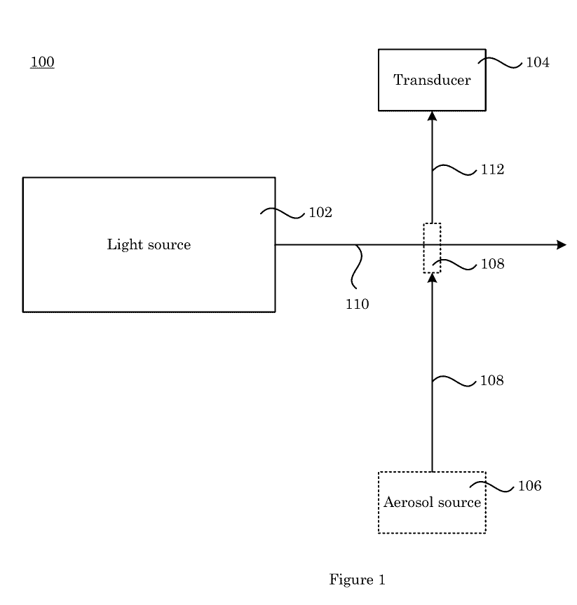

In an embodiment, as shown in FIG. 1, photoacoustic spectrometer 100 includes light source 102 to irradiate nondestructively sample 108 and to provide probe light 110 and transducer 104 to detect photoacoustic signal 112. Photoacoustic signal 112 is produced from sample 108 in response to absorption of probe light 110 by sample 108. Probe light 110 includes an acoustic frequency and a high frequency. In some embodiments, aerosol source 106 is included in photoacoustic spectrometer 100 to provide sample 108.

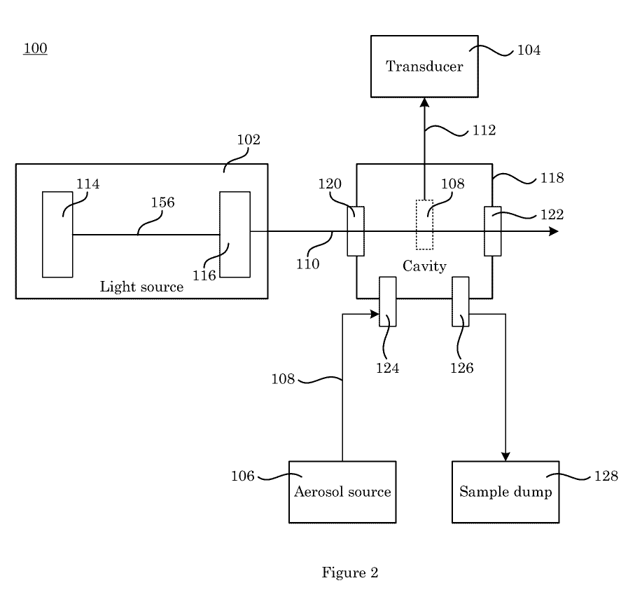

According to an embodiment, sample 108 is disposed in free-space. In an embodiment, as shown in FIG. 2, photoacoustic spectrometer 100 includes cavity 118 that is in optical communication with light source 102, wherein sample 108 is disposed in cavity 118 to be subjected to probe light 110. Cavity 118 includes first window 120 to communicate probe light 110 into cavity 118. Second window 122 can be disposed on cavity 118 to communicate probe light 110 from cavity 118 to outside of cavity 118. Cavity 118 can be isolated from the environment external to cavity 118 (e.g., a closed cavity as shown in FIG. 2) or can be in fluid communication with the environment external to cavity 118 (e.g., an open cavity, not shown). Cavity 118 can include inlet 124 in fluid communication with aerosol source 106 to receive sample 108 from aerosol source 106 and to introduce sample 108 from aerosol source 106 into cavity 118. Cavity 118 also can include outlet 126 in fluid communication with sample dump 128 to communicate sample 108 from cavity 118 to sample dump 128. Cavity 118 can be a resonant cavity or a non-resonant cavity.

In an embodiment, cavity 118 is the resonant cavity such that cavity 118 includes both a resonant mode and a non-resonant mode. The resonant mode includes a resonant frequency, wherein cavity 118 produces a standing wave at acoustic frequency AF provided by probe light 110 or sample 108. The non-resonant mode includes a non-resonant frequency. The non-resonance mode can be much lower in frequency than the resonant frequency. Here, cavity 118 excites a plurality of resonant frequencies beyond acoustic frequency AF.

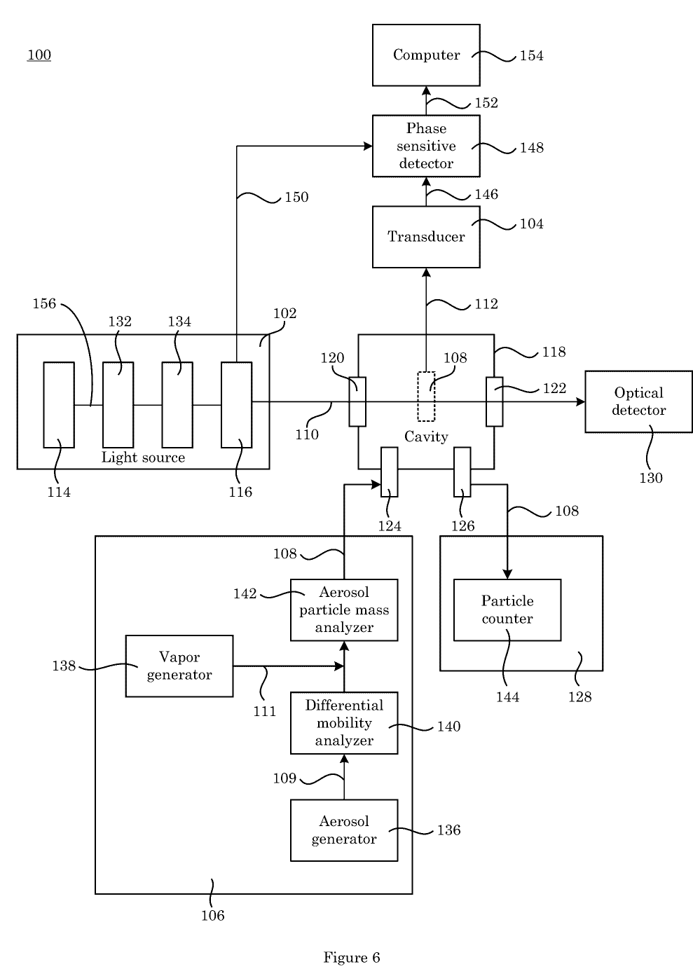

Transducer 104 produces electrical signal 146 (not shown in FIG. 2 but see FIG. 6) in response to receiving photoacoustic signal 112 produced by sample 108 in response to being subjected to probe light 110. Transducer 104 can be connected directly to cavity 118 to receive photoacoustic signal 112 from sample 108. Spectrometer signal 146 is communicated to detector 148 such as a phase sensitive detector (e.g., see FIG. 6).

Here, light source 102 can include first light source to produce first light 156 that includes the high frequency. Light source 102 also can include modulator 116 to receive first light 156 and to modulate first light 156 at an acoustic frequency to produce probe light 110.

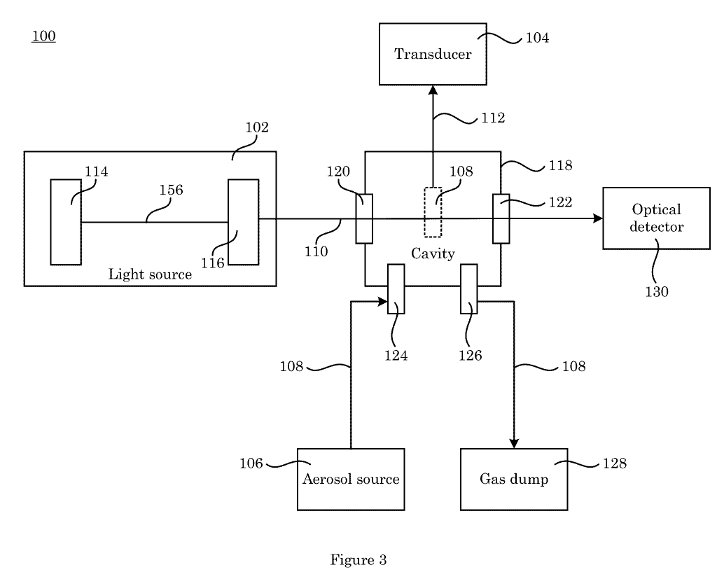

In an embodiment, as shown in FIG. 3, photoacoustic spectrometer 100 includes optical detector 130 in optical communication with light source 102. Optical detector 130 detects probe light 110. In some embodiments, cavity 118 is interposed between light source 102 and optical detector 130, wherein sample 108 is disposed in cavity 118 and subjected to probe light 110. In a certain embodiment, sample 108 is disposed in free space and subjected to probe light 110, wherein optical detector 130 receives probe light 110 after passing through sample 108. In an embodiment, sample 108 is absent from a path of probe light 110 such that optical detector 130 receives probe light 110 in the absence of sample 108. It is contemplated that cavity 118 is present or absent between light source 102 and optical detector 130.

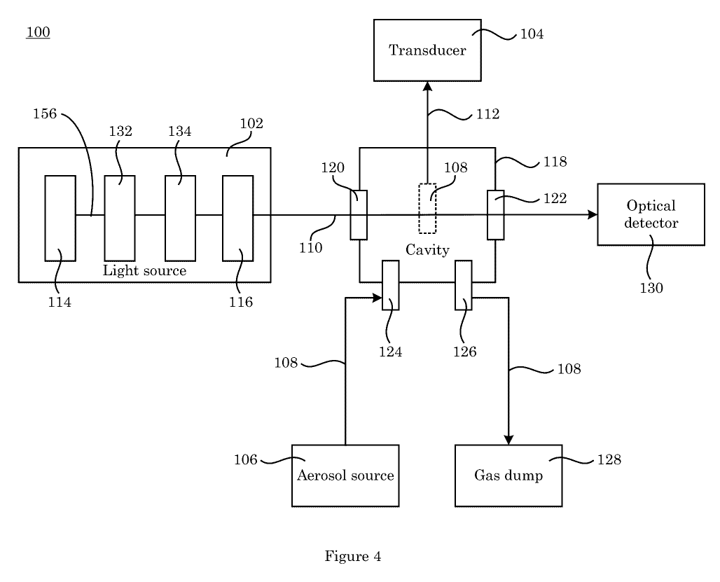

In an embodiment, as shown in FIG. 4, light source 102 includes wavelength filter 132 to receive first light 156 from first light source 114 and to select a wavelength (e.g., a center wavelength) of first light 156. First light 156 is communicated from wavelength filter 132 to bandwidth filter 134 that selects a bandwidth of first light 156 around the center wavelength specified by wavelength filter 132. In this manner, light source 102 produces probe light 110 that is communicated to sample 108, cavity 118, optical detector 130, or combination thereof.

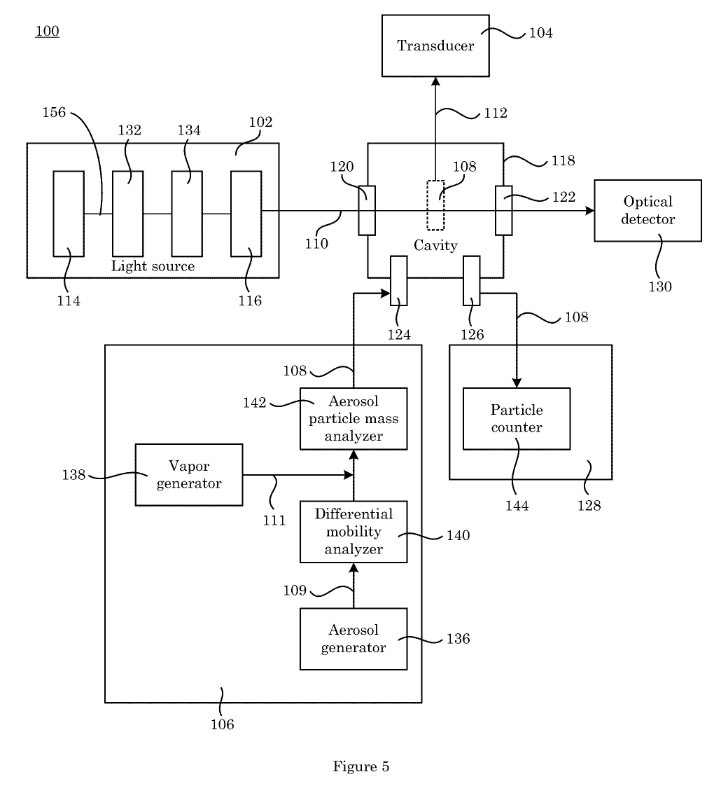

In an embodiment, as shown in FIG. 5, aerosol source 106 is in fluid communication with inlet 124 to provide sample 108 to cavity 118. Aerosol source 106 can include aerosol generator 136 to produce an aerosol, differential mobility analyzer 140 in fluid communication with aerosol generator to receive the aerosol, aerosol particle mass analyzer 142 in fluid communication with differential mobility analyzer 140 and aerosol generator 136, and vapor generator 138 that is in fluid communication with aerosol generator 136 to provide a level of gas vapor to the aerosol. Aerosol source 106 produces the aerosol communicated to differential mobility analyzer 140 to select an aerosol of a desired mobility diameter. Differential mobility analyzer 140 communicates electrical mobility size-selected aerosol to aerosol particle mass analyzer 142 to select an aerosol of a desired mass. In this manner, sample 108 is produced by aerosol source 106.

Additionally, photoacoustic spectrometer 100 can include particle counter 144 in fluid communication with outlet 126 to receive sample 108. Particle counter 144 determines a number density of particles in sample 108 by counting particle scattering at a known flow rate.

In an embodiment, as shown in FIG. 6, photoacoustic spectrometer 100 includes phase-sensitive detector 148 in electrical communication with transducer 104 to receive spectrometer signal 146 from transducer 104. Spectrometer signal 146 is produced by transducer 104 in response to receiving photoacoustic signal 112 from sample 108. Phase sensitive detector 148 also receives reference signal 150 from light source 102 in which modulator 116 produces reference signal 115 to phase-lock phase-sensitive detector. Reference signal 150 has a frequency at the acoustic frequency at which modulator 116 amplitude modulates first light 156. Phase sensitive detector 148 produces phase-locked signal 152 based on detecting spectrometer signal 146 at the acoustic frequency provided by reference signal 150. Phase-locked signal 152 can be communicated and received by computer 154 that can store or analyze phase-locked signal 152 to provide the absorption of sample 108 via production of photoacoustic signal 112 in response to being subjected to probe light 110.

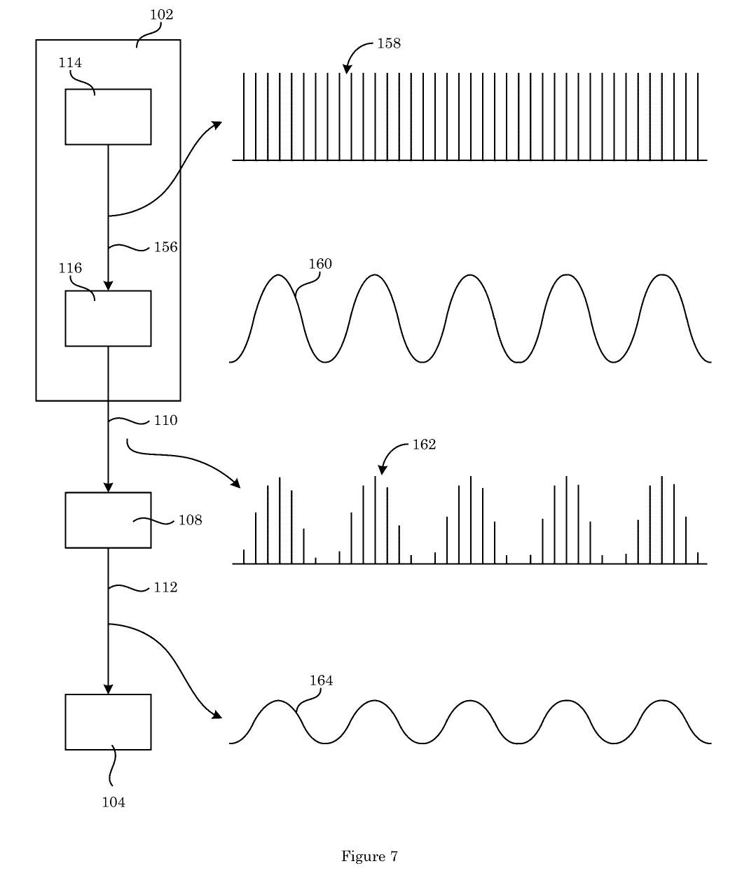

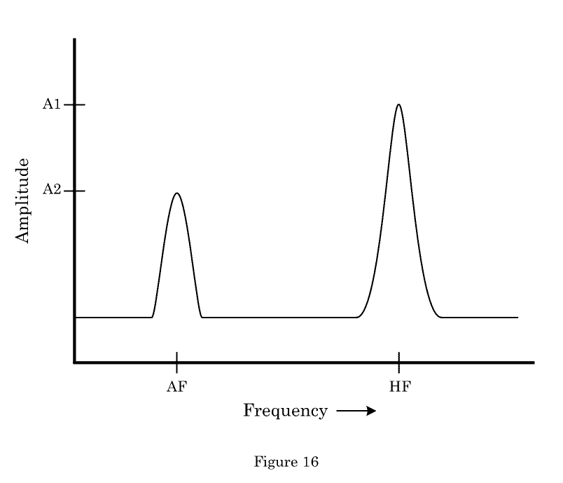

Photoacoustic spectrometer 100 includes light source 102 to produce probe light 110. Light source 102 produces first light 110 that has a frequency spectrum as shown in FIG. 16, which is a graph of amplitude versus frequency. Here, first light 110 includes high frequency HF and acoustic frequency AF that are amplitude modulated. With reference to FIG. 7, first light source 114 produces first light 156 that has high-frequency HF and primary waveform 158. Modulator 116 receives first light 156. Modulator 116 subjects first light 156 to modulation at acoustic frequency AF included in modulation waveform 160. In this manner, probe light 110 is produced by light source 102 and has probe waveform 162. Sample 108 is subjected to probe light 110 having probe waveform 162 and produces photoacoustic signal 112 having acoustic waveform 164. Acoustic waveform 164 has a frequency that is substantially similar to acoustic frequency AF. In an embodiment, acoustic waveform 164 has a frequency that is equivalent to acoustic frequency AF. Photoacoustic signal 112 is communicated from sample 108 and received by transducer 104 that produces a spectrometer signal 146 that has a frequency and amplitude substantially similar to photoacoustic signal 112 and acoustic waveform 164.

First light source 114 can be a pulsed light source (e.g., a pulsed laser), continuous wave (CW) light source (e.g., a diode laser), and the like. In an embodiment, first light source 114 is a pulsed laser that directly produces primary waveform 158. In some embodiments, first light source 114 is a pulsed laser that produces a primary waveform that is subjected to modification (e.g., optical chopping) to produce primary waveform 158. In a particular embodiment, first light source 114 is a CW light source that produces a primary waveform that is subjected to modification (e.g., optical chopping) to produce primary waveform 158.

Exemplary first light sources 114 include a supercontinuum laser, an optical parametric oscillator, optical parametric amplifier, and the like. In an embodiment, first light source 114 is the supercontinuum laser. It should be appreciated that the supercontinuum laser includes a short pulse pump laser directed into a nonlinear optical fiber to disperse the pulse in time and light frequency (i.e. wavelength). This output pulse is used as first light 156.

Photoacoustic spectrometer 100 includes modulator 116 to receive first light 156 from first light source 114 and to modulate the first light 156 to produce a probe light 110. Modulator 116 can be an optical modulator, mechanical modulator, or a combination thereof. Exemplary optical modulators include an acousto-optic modulator and the like. Exemplary mechanical modulators include a mechanical chopper, shutter, and the like. In an embodiment, modulator 116 is the mechanical chopper that modulates first light 156 at acoustic frequency AF.

Photoacoustic spectrometer 100 includes wavelength filter 132 to receive first light 156 from first light source 114 and to select a wavelength of first light 156. Wavelength filter 132 can be a tunable wavelength filter or fixed wavelength filter. Exemplary wavelength filters 132 include a monochromator, glass filter, acousto-optic tunable filter, and the like.

Photoacoustic spectrometer 100 includes bandwidth filter 134 to receive first light 156 from first light source 114 and to select a bandwidth of first light 156 around the wavelength specified by wavelength filter 132. Bandwidth filter 134 can be a tunable bandwidth filter or fixed bandwidth filter. Exemplary bandwidth filters 134 include a combination linear long- and short-pass filters, variable bandwidth tunable filters, and the like.

In an embodiment, as shown, e.g., FIG. 4, FIG. 5, FIG. 6. Bandwidth filter 134 and wavelength filter 132 are interposed between first light source 114 and modulator 116. In some embodiments, bandwidth filter 134 or wavelength filter 132 are present in interposed between modulator 116 and sample 108. Moreover, bandwidth filter 134 can be positioned closer to first light source 114 than wavelength filter 132.

First light 156 produced by first light source 114 can propagate in free space or an optical fiber between any of first light source 114, wavelength filter 132, bandwidth filter 134, and modulator 116. Further, it is contemplated that probe light 110 can propagate in free space or in an optical fiber between light source 102 and sample 108, between sample 108 and optical detector 130, and the like. Optical fiber can be single mode or multimode.

Photoacoustic spectrometer 100 includes cavity 118. Cavity 118 receives probe light 110 from light source 102 via first window 120. Sample 108 is disposed in cavity 118 and receives probe light 110. Probe light 110 includes high frequency HF and acoustic frequency AF. In an embodiment, cavity 118 is a resonant cavity, wherein cavity 118 is resonant at a selected amplitude modulation frequency of probe light 110 such as 1640 Hz at 296 K in ambient air. Cavity 118 can have a shape effective to receive sample 108 and probe light 110. Exemplary shapes include cylindrical, cubic, symmetric, asymmetric, and the like. Cavity 118 can be made of material effective to obtain a certain pressure inside cavity 118, e.g., an internal pressure from 10⁻⁷ Pascals (Pa) to 5.06×10⁵ Pa, specifically from 2.65×10⁴ Pa to 1.02×10⁵ Pa (e.g., atmospherically relevant pressures). Exemplary materials include a metal (stainless steel, brass, copper, aluminum, alloys thereof, and the like), a polymer (e.g., a thermoset polymer such as polyvinylchloride; a polycarbonate such as Lexan (a trademark of polycarbonate polymer commercially available from Sabic), and the like), ceramic, glass, and the like. A pressure regulator, flow controller, vacuum pump, valve, analytical instrument (e.g., mass spectrometer, chromatograph, and the like), pressure gauge, and the like can be attached to cavity 118 to monitor or regulate a condition inside cavity 118.

First window 120 and second window 128 are included in photoacoustic spectrometer 100 to communicate optically probe light 110 into and out of cavity 118. A size and shape of windows 120 and 128 are selected to provide optical communication of probe light 110 therethrough. Window (120, 128) includes a material that is optically transparent of probe light 110. Exemplary materials for windows 120, 120 include silica, glass, sapphire, LiF, NaCl, MgF₂, MgCl₂, KBr, CaF₂, and the like.

In an embodiment, cavity 118 includes inlet 124 and outlet 126 to communicate sample 108 into and out of cavity 118. Inlet 124 and outlet 126 independently can be a valve (e.g., an on-off valve, flow constrictor, orifice and the like), flow controller, and the like. A mass flow or pressure in cavity 118 of sample 108 can be controlled via inlet 124 or outlet 126.

In an embodiment, photoacoustic spectrometer 100 includes sample dump 128 in fluid communication with cavity 118. Here, sample dump 128 receives sample 108 communicated from cavity 118. Sample dump 128 can include a reservoir to contain sample 108, a filter to filter sample 108 before communicating sample 108 to the surrounding environment, a vacuum pump to pump sample 108 from cavity 118, and the like. Sample dump 128 or cavity 118 can be in fluid communication with aerosol source 106 to recirculate sample 108 to aerosol source 106.

Sample dump 128 can include particle counter 144 to count a number of particles in sample 108. Particle counter 144 can selectively count particles in sample 108 based on a mass or size of the particles or combination comprising at least one of the foregoing. Accordingly, particle counter 144 can provide a mass distribution of particles, a size distribution of the particles, or a combination thereof.

According to an embodiment, photoacoustic spectrometer 100 includes transducer 104 to receive photoacoustic signal 112 from sample 108 and to produce spectrometer signal 146 in response to receiving photoacoustic signal 112. Accordingly, transducer 104 transforms photoacoustic frequency AF of photoacoustic signal 112 into a spectrometer signal that includes acoustic frequency AF. Exemplary transducers 104 include a microphone, piezoelectric transducer, micro-electro-mechanical systems, and the like.

Phase-sensitive detector 148 receives spectrometer signal 146 from transducer 104 and produces phase-locked signal 152 in response to receipt of spectrometer signal 146. Phase-sensitive detector 148 can also receive reference signal 150 from modulator 116 to phase-lock phase-sensitive detector 148 to modulation frequency of modulator 116 that occurs at the acoustic frequency AF. In this manner, phase-locked signal 152 can be a direct current voltage that has a magnitude proportional to an amount of sample 108 that absorbed probe light 110.

In an embodiment, probe light 110 is amplitude modulated, split, and recombined prior to receipt by sample 108. In a particular embodiment, a secondary probe light is also used, wherein the secondary probe light has a different modulation frequency than that of the probe light 110 such phase-sensitive detector 148 measures a beat frequency of the two modulation frequencies. Here, the phase-lock signal is at either a sum or a difference of the two modulation frequencies.

In an embodiment, photoacoustic spectrometer 100 includes optical detector 130 to detect probe light 110. Optical power detector 130 receives probe light 110 and produces an electrical signal is proportional to a power of probe light 110. Exemplary optical detector 130 includes a power meter, a photodiode, a photomultiplier tube, a thermopile sensor, a pyroelectric sensor, an integrating sphere, or a combination thereof. A wavelength selector such as an optical filter or monochromator can be interposed between probe light 110 an optical detector 130 to select the wavelength of probe light 110 that is received by optical detector 130.

According to an embodiment, photoacoustic spectrometer 100 includes aerosol source 106 to produce sample 108. Aerosol source 106 includes aerosol generator 136 to produce aerosol 109. Exemplary aerosol generators 136 include cross-flow atomizers, electrospray atomizers, vibrating orifice atomizers, Santoro diffusion flames and the like.

Aerosol source 106 can include differential mobility analyzer 140 to size select particles based upon mobility within an electrical field. Exemplary differential mobility analyzers 140 include Vienna- and Hauke-type, and the like. Differential mobility analyzer 140 receives aerosol 109 from aerosol generator 136 and communicates aerosol 109 to aerosol particle mass analyzer 142.

Aerosol source 106 can include aerosol particle mass analyzer 142 to receive aerosol 109 from differential mobility analyzer 140 and to mass separate aerosols based upon a balance between centrifugal and electrostatic forces within a rotating annular area. Exemplary aerosol particle mass analyzers 142 include the aerosol particle mass analyzer, coquette particle mass analyzer and fluted particle mass analyzer, and the like.

Aerosol source 106 can include vapor generator 138 to produce coating composition 111 in a vapor. Vapor from vapor generator 138 is communicated from vapor generator 138 and disposed along aerosol 109 to dispose coating composition 111 on particles of aerosol 109. Exemplary vapor generators 138 include condensational growth chambers, Peltier-based water saturators, and the like. Coating compositions 111 can be a hydrophilic composition or hydrophobic composition. Exemplary coating compositions 111 include inorganic species (e.g., water, sulfuric acid, and the like), an organic species (e.g., an alcohol, aromatic, semi- or low-volatility humic-like substance, and the like), or combination thereof. In an embodiment, coating composition 111 is water. It is contemplated that a thickness of water in coating composition 111 is controlled by vapor generator 138. In this manner, aerosol source 106 produces sample 108 that is communicated from aerosol source 106 to be subjected to probe light 110.

In an embodiment, aerosol source 106 can include a sampler to sample from an environment such as air, a vessel (e.g., a gas cylinder, and the like), and the like. Here, aerosol source 106 obtains a portion of a volume of gas from the environment and provides a portion as sample 108. According to an embodiment, aerosol source 106 can have the sampler in an absence or presence of any of differential mobility analyzer 140, vapor generator 138, or aerosol particle mass analyzer 142.

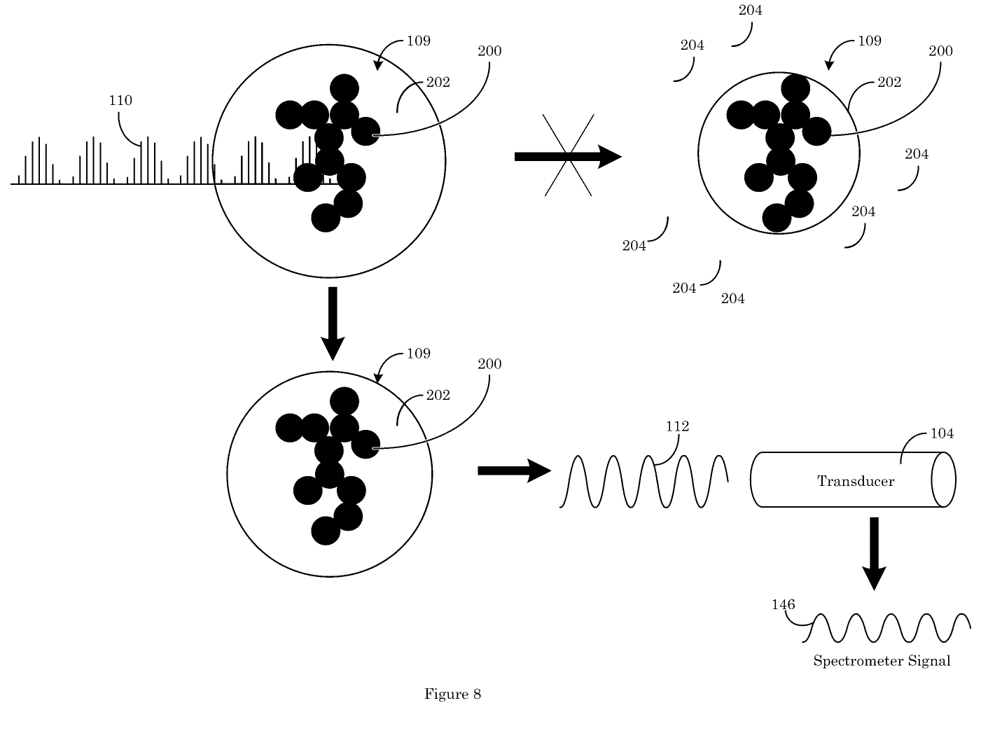

In an embodiment, in photoacoustic spectrometer 100, sample 108 is subjected to probe light 110, and sample 108 produces photoacoustic signal 112 in response to absorption of energy from probe light 110. Sample 108 can include aerosol 109 alone or in combination with coating composition 111. According to an embodiment, sample 108 includes aerosol 109 that includes a plurality of particles 200 and coating composition 202 disposed on particles 200 as shown in FIG. 8.

In an embodiment, particles in aerosol 109 are coated with coating composition 111 that can include an organic material, inorganic material, water, and the like. Coating composition 111 can direct probe light 110 into a core of particles of sample 108, increasing an amount of probe light 110 absorbed by sample 108 as compared to aerosol 109 in sample 108 that does not include coating composition 111 disposed on particles of aerosol 109. Accordingly, photoacoustic spectrometer 100 measures absorption enhancement of particles in sample 108 coated with volatile or semi-volatile materials contained in coating composition 111 disposed on particles in sample 108.

Exemplary samples include monodisperse polystyrene spheres, soot from flames, dye particles, atmospheric samples, and the like.

According to an embodiment, photoacoustic spectrometer 100 includes light source 102 that includes the supercontinuum laser to produce first light 156 including high-frequency HF; tunable wavelength filter 132 to select a wavelength of first light 156; bandwidth filter 134 to filter the bandwidth of first light 156; modulator 116 to receive first light 156 and to modulate first light 156 at acoustic frequency AF to produce probe light 110 including: acoustic frequency AF; and high-frequency HF, light source 102 to irradiate nondestructively sample 108 with probe light 110; cavity 118 to receive sample 108 and probe light 110 and including: first window 120 to transmit probe light 110 into cavity 118; and second window 122 to transmit probe light 110 out of cavity 118; transducer 104 to detect photoacoustic signal 112 produced from sample 108 in response to absorption of probe light 110 by sample 108; and optical detector 130 to detect probe light 110.

In an embodiment, a process for performing photoacoustic spectroscopy includes producing first light 110 including high-frequency HF; modulating first light 156 at acoustic frequency AF to produce probe light 110 including: acoustic frequency AF; and high-frequency HF; communicating probe light 110 to cavity 118; providing sample 108 to cavity 118; irradiating nondestructively sample 108 with probe light 110; producing photoacoustic signal 112 by sample 108 in response to absorption of probe light 110 by sample 108; and detecting photoacoustic signal 112 to perform photoacoustic spectroscopy on sample 108.

According to an embodiment, the process for performing photoacoustic spectroscopy also includes detecting probe light 110; and producing reference signal 150 based on detected probe light 110. Detecting photoacoustic signal 112 can include phase-locking to reference signal 150.

In an embodiment, sample 108 includes aerosol 109 of black carbon particles such as a soot produced from combustion of a hydrocarbon such as ethylene. Further, a portion of aerosol 109 can be coated with coating composition 111 that includes water such that sample 108 includes water coated black carbon particles and carbon particles without water adsorbed thereto. Sample 108 is subjected to probe light 110 to produce photoacoustic signal 112. Here, an enhancement of 20 percent for particles with the water coating occurred. As a comparison, no enhancement in photoacoustic signal 112 was detected for sample 108 in which a CW laser irradiated sample 108 instead of probe light 110. CW laser was modulated with acoustic frequency AF and without high frequency HF.

Photoacoustic spectrometer 100 has beneficial and advantageous properties. According to an embodiment, sample 108 includes aerosol 109 that includes a plurality of particles 200 and coating composition 202 disposed on particles 200 as shown in FIG. 8. Aerosol 109 is subjected to probe light 110. In a presence of probe light 110, particles 200 of aerosol 109 of sample 108 absorb energy from probe light 110. Due to absorption of energy from probe light 110, aerosol 109 is heated. Here, aerosol 109 transfers energy to surrounding gas via collisions that warms the surrounding gas to produce photoacoustic signal 112 having acoustic frequency AF. Due to optical properties of probe light 110, 109 maintains particles 200 coated by coating composition 202 without evaporation of coating 202 or elimination of particles 200 from aerosol 109 such that aerosol 109 does not experience a change in mass, a change in composition, or a change in size after being subjected to probe light 110. In this manner, photoacoustic signal 112 is produced by aerosol 109 of sample 108 that is changed from before absorption of probe light 110 and producing photoacoustic signal 112. Accordingly, light source 102 irradiates sample 108 with probe light 110. As a result, photoacoustic signal 112 received by transducer 104 has acoustic frequency AF that matches acoustic frequency AF of probe light 110 and which has an amplitude indicative of a total number of aerosol particles 109 irradiated by probe light 110.

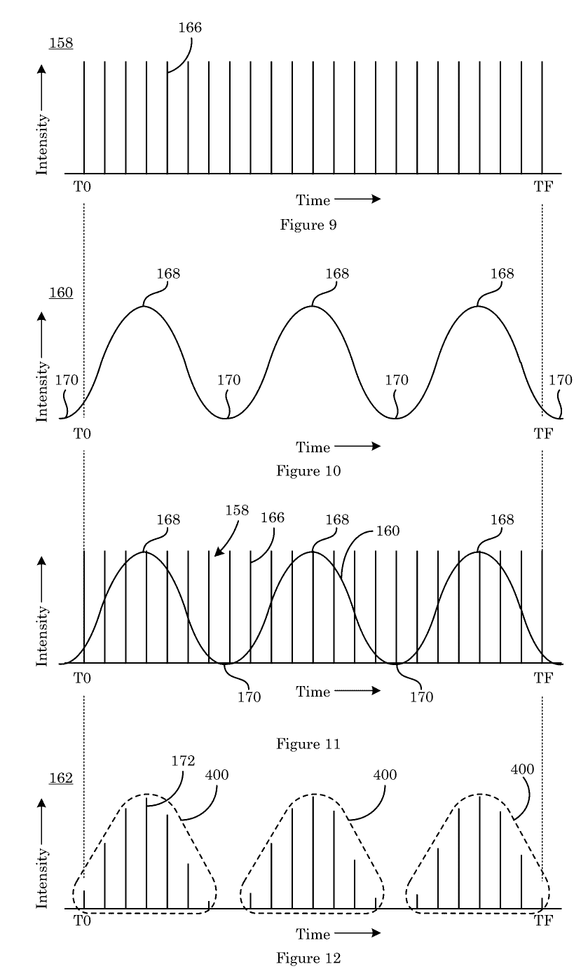

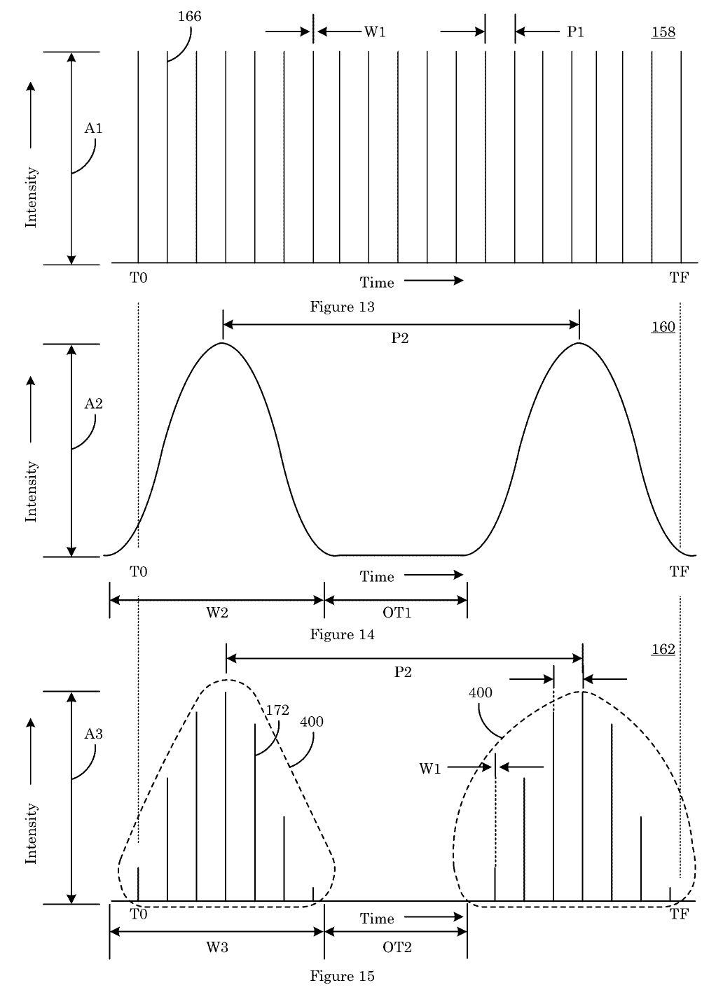

In an embodiment, with reference to FIG. 9 and FIG. 13, first light source 114 produces first light 156 that has primary waveform 158 and includes a plurality of first light pulses 166. First light pulses 166 have first pulse width W1, and neighboring first light pulses 166 are separated by first period P1. High-frequency HF is provided by first period P1. First light pulses 166 have intensity amplitude A1.

First pulse width W1 can be from 20 picoseconds (ps) to 5 nanoseconds (ns). In an embodiment, first pulse width W1 is 650 ps. First period P1 can be from 100 ps to 25 ns. In an embodiment, first period P1 is equal to 12.8 ns. In a particular embodiment, first pulse width P1 is 650 ps. Consequently, high-frequency HF can be from 50 megaHertz (MHz) to 1 gigaHertz (GHz). In a particular embodiment, high-frequency HF is 78 MHz.

A duty cycle of first light 156 can be from 1 percent (%) to 50%. In an embodiment, the duty cycle of first light 156 is 5%.

First light 156 can be monochromatic or polychromatic. A wavelength of first light 156 that sufficiently occupies any of the atmospheric transmission windows, specifically from 500 nm to 840 nm, and more specifically from 640 nm to 680 nm. In an embodiment, the wavelength of first light 156 is 660 nm. Wavelength filter 132 can receive first light 156 and select a wavelength of first light 156 to a selected wavelength or band of wavelengths.

First light 156 can have a bandwidth from 0.01 nm to 100 nm, and more specifically from 10 nm to 30 nm. In an embodiment, the wavelength of first light 156 is 20 nm. Bandwidth filter 134 can receive first light 156 and select a bandwidth of first light 156 to a selected bandwidth.

According to an embodiment, first light source 114 that produces first light 156 is the supercontinuum laser that, e.g., has a wavelength located between 500 nm and 840 nm, first pulse width W1 of 650 ps, high-frequency HF of 78 MHz, and bandwidth of 20 nm.

In an embodiment, with reference to FIG. 10 and FIG. 14, modulator 116 receives first light 156 from first light source 114 that has primary waveform 158 and includes a plurality of first light pulses 166. Modulator 116 subjects first light 156 to modulation as shown as modulation waveform 160 in FIG. 10 and FIG. 14. Modulation waveform 160 includes modulation peaks 168 separated by modulation minimum 170 with second period P2.

Modulation peaks 168 have second pulse width W2, and modulation minimum 170 provides modulation waveform 160 with first off-time OT1. Acoustic frequency AF is provided by second period P2. Modulation peak 168 has intensity amplitude A2.

Second pulse width W2 can be from 25 milliseconds (ms) to 25 microseconds (μs), specifically from 5 ms to 50 μs, and more specifically from 1 millisecond (ms) to 100 μs. In an embodiment, second pulse width W2 is 307 μs. Second period P2 can be from 50 ms to 50 μs, specifically from 10 ms to 100 μs, and more specifically from 2 ms to 200 μs. In an embodiment, second period P2 is 614 μs and second pulse width W2 is 307 μs. Consequently, acoustic frequency AF can be from 20 Hertz (Hz) to 20 kiloHertz (kHz), specifically from 100 Hz to 10 kHz, and more specifically from 500 Hz to 5 kHz. In a particular embodiment, acoustic frequency AF is 1.6 kHz.

A duty cycle of modulation waveform 160 can be from 1 percent (%) to 50%, specifically duty cycle less than or equal to 50% but sufficiently high to generate the photoacoustic signal. In an embodiment, the duty cycle of modulation waveform 160 is 50%.

In an embodiment, modulation waveform 160 has a duty cycle of 50%, second pulse width W2 is 307 μs.

Modulation waveform 160 can be selected to have any temporal shape effective to modulate first light 156 in order to produce photoacoustic signal 112 when sample 108 is irradiated by light source 102. Exemplary shapes of modulation waveform 160 include square wave, triangular, boxcar, and sine, and the like. According to an embodiment, modulation waveform 160 is in a well-defined sequence of modulation peaks 168 such that cross correlation can be performed on photoacoustic signal 112, spectrometer signal 146, or phase-locked signal 152 to determine the absorption coefficient for sample 108.

FIG. 11 shows an overlap between modulation waveform 160 of modulator 116 and primary waveform 158 of first light 156. When first light 156 is subjected to modulation waveform 158 from modulator 116, light source 102 produces probe light 110 as shown as probe waveform 162 in FIG. 12 and FIG. 15.

Probe waveform 162 includes a plurality of probe light pulses 172 grouped into packets 400 separated by second off-time OT2 with second period P2. Packets 400 of probe light pulses 172 have third pulse width W3, wherein individual probe light pulses 172 have first pulse width W1 provided by first light pulses 166 from first light 156. Closest neighboring probe light pulses 172 are separated by first period P1. Accordingly, probe waveform 162 of probe light 110 includes high-frequency HF from primary waveform 158 and acoustic frequency AF from modulation waveform 160 as shown in FIG. 16.

Here, third pulse width W3 is substantially similar or identical to second pulse width W2 of modulation waveform 160. Probe light pulses 172 have a maximum intensity amplitude A3 and vary according to intensity of modulation waveform 160. In this manner, a plurality of probe light pulses 172 are grouped into packets 400 and have an intensity that varies according to modulation waveform 160.

A property (first pulse width W1, first period P1, high-frequency HF, duty cycle, chromaticity, bandwidth, third pulse width W3 based on second pulse width W2, second period P2, intensity, and the like) of probe light 110 that has probe waveform 162 can be identical or substantially similar to such property of a superposition of primary waveform 158 and modulation waveform 160, respectively from first light 156 and modulator 116.

According to an embodiment, probe light 110 from light source 100 to has a wavelength of 660 nm, first pulse width W1 of 650 ps, third pulse width W3 of 307 μs, second off time OT2 307 μs, high-frequency HF of 78 MHz, bandwidth of 20 nm, and acoustic frequency AF of 1640 Hz.

Advantageously, photoacoustic signal 112 and determination of absorption of probe light 110 by sample 108 is independent of a wavelength of probe light 110. Aerosol particles 109 in sample 108 can be subjected to probe light 110 that includes a single wavelength or a plurality of wavelengths. In an embodiment, the wavelength is from 480 nm to 840 nm.

In an embodiment, high-frequency HF is a frequency greater than or equal to 50 MHz; and first light 156 includes first pulse width W1 less than or equal to 650 picoseconds and a duty cycle less than or equal to 10%. Acoustic frequency AF can be less than high-frequency HF, and second pulse width W2 of modulation waveform 160 subjected to first light 156 is 1 millisecond (ms) to 100 μs.

Photoacoustic spectrometer 100 and processes herein have numerous advantages and benefits in that the current design of photoacoustic spectrometer allows for the absorption measurement of particles with volatile or semi-volatile coating 138.

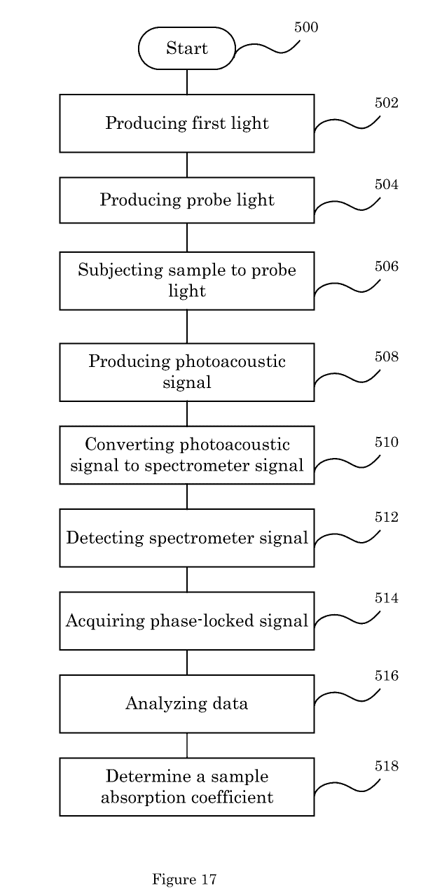

Photoacoustic spectrometer 100 has a plurality of beneficially uses. In an embodiment, photoacoustic spectrometer 100 performs photoacoustic spectroscopy on sample 108 under a broad range of conditions. In an embodiment, with reference to FIG. 17, a process (500) for performing photoacoustic absorption spectroscopy of sample 108 includes producing first light (step 502), producing probe light (step 504), subjecting sample 108 to probe light (step 506), producing photoacoustic signal (step 508), converting (e.g., by transduction) photoacoustic signal to spectrometer signal (step 510), detecting spectrometer signal by phase-sensitive detector (step 512), acquiring phase-locked signal by computer (step 514), analyzing data based on phase-locked signal (step 516), and subjecting analyzed signal to a calibration constant to determine a sample absorption coefficient (step 518).

In an embodiment, photoacoustic spectrometer 100 provides quantification of absorption of probe light 110 by sample 108 acquired from a field campaign or a laboratory environment. According to an embodiment, photoacoustic spectrometer 100 quantitatively measures light absorption of sample 108 that includes a volatile or semi-volatile coating composition 111.

The articles and processes herein are illustrated further by the following Examples, which are non-limiting.

### Examples

### Example 1

### Photoacoustic Spectrometer

A photoacoustic spectrometer 100 was constructed to perform photoacoustic spectroscopy on a sample 108 of aerosol from an aerosol source 106. Light source 102 included first light source 114 that generated first light 156 with high frequency HF. A wavelength and bandwidth of first light 156 were selected respectively by wavelength filter 132 and bandwidth filter 134, and first light 156 was modulated by a modulator 116 to generate probe light 110. Probe light 110 was communicated to sample 108 and to optical detector 130. Photoacoustic signal produced by sample 108 in response to probe light 110 and was detected by transducer 104.

### Example 2

### Photoacoustic Spectroscopy

A sample was disposed in cavity 118 of the photoacoustic spectrometer 100 of Example 1. The sample 108 was generated from an aerosol generator 136, which in the present example was soot from a Santoro diffusion flame operated on ethylene fuel. Aerosol generator 136 was in fluid communication with a differential mobility analyzer 140 for size selection of the aerosol. The differential mobility analyzer was in fluid communication with vapor generator 138 and aerosol particle mass analyzer 142. Vapor generator 138 was identical or substantially similar to a humidity generator to deposit a coating of water from vapor 111 generated by vapor generator 138. Aerosol particle mass analyzer 142 was used to mass select coated aerosol constituting sample 108 for measurement by photoacoustic spectrometer 100. Sample 108 was drawn through aerosol generator 136, differential mobility analyzer 140, aerosol particle mass analyzer 142, sample inlet 124, sample cavity 118 and sample outlet 126 by a condensation particle counter 144.

Light source 102 consisted of a first light source 114 that was a supercontinuum laser that generated first light 156 with high frequency HF. First light 156 was selected by a wavelength filter 132 to have a center wavelength of 660 nm. This first light was also selected by a bandwidth filter 134 to have a bandwidth of 20 nm around the center wavelength selected by the wavelength filter 132. The wavelength and bandwidth selected first light was then passed in free space to a modulator 116 consisting of a mechanical chopper for modulation of first light 156 at the acoustic frequency AF. In this way, the probe light 110 was generated from light source 102.

Probe light 110 was then optically communicated through the first window 120 into cavity 118 for interrogation of sample 108 and then optically communicated out of cavity 118 through second window 122 to an optical detector 130 which was substantially similar to an optical power meter.

Absorption of probe light 110 by sample 108 disposed in cavity 118 generated photoacoustic signal 112 that was communicated to a transducer 104 that was substantially similar to an electret microphone. Transducer 104 produced spectrometer signal 146 that was electrically communicated to phase-sensitive detector 148 which is substantially similar to a lock-in amplifier that was phase-locked to reference signal 150 generated by modulator 116. Phase-locked signal 152 was electrically communicated to a computer 154.

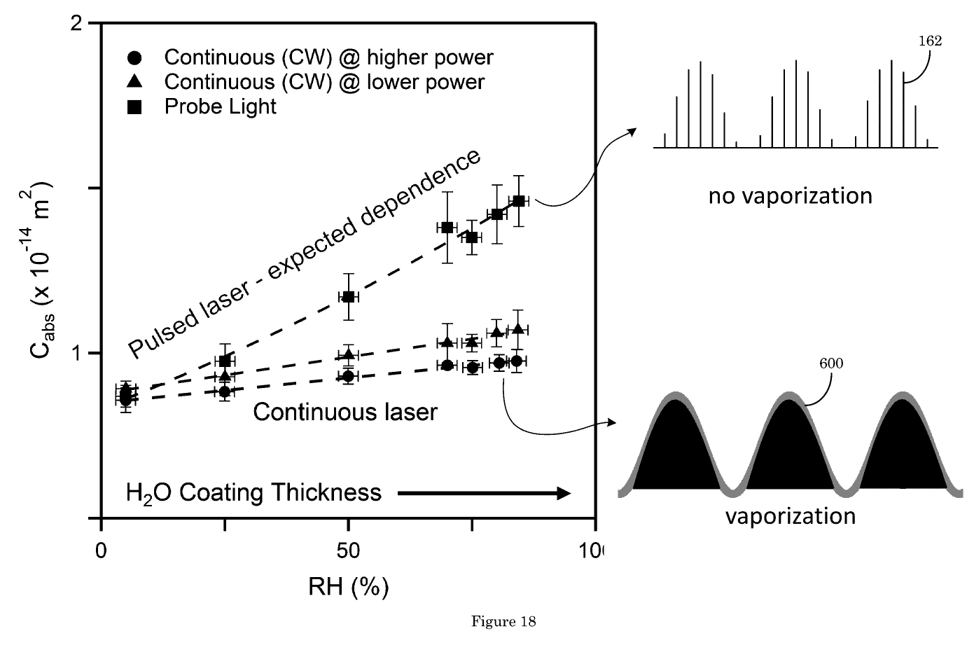

From phase-locked signal 152, the light intensity measured by optical detector 130 and the number concentration of particles measured by the particle counter 144, the absorption cross-section (C_{abs}) of the soot sample 108 was determined. A graph of C_{abs} versus relative humidity (RH), and hence coating thickness from vapor 111, is shown in FIG. 18 in which the squares indicate C_{abs} for the sample subjected to the probe light of the photoacoustic spectrometer. Here, the probe light had probe waveform 162, with an acoustic frequency duty cycle of 50% and a high frequency duty cycle of 5%. Because probe light 110 had waveform 162, the sample absorbed energy nondestructively from the probe light 110, and the coating composition did not evaporate from the sample during irradiation of the sample with the probe laser.

### Example 3

### Comparative Data

The sample 108 described in Example 2 was disposed in the cavity 118 of the photoacoustic spectrometer 100 of Example 1. Instead of generating first light 156 with high frequency component HF as part of probe light 110, a continuous wave (CW) laser was used that did not possess high frequency component HF. The CW laser was still subjected to wavelength filter 132 and bandwidth filter 134; the CW laser outputs light at a center wavelength of 660 nm with a bandwidth of 5 nm. The CW laser light was modulated by modulator 116 that was sufficiently similar to a mechanical chopper at the acoustic frequency AF. All other components of the measurement were sufficiently similar to the measurement described in Example 2.

Two comparative experiments were performed using the CW laser with a lower average power (25 milliwatts (mW)) and higher average power (100 mW). Data with the CW laser is also shown in FIG. 18 in which triangular data points indicate the absorption cross section (C_{abs}) for the sample subjected to the CW laser at lower power, and circular data points indicate C_{abs} for the sample subjected to the CW laser at higher power. For the comparative data of Example 3, the CW laser had CW waveform 600 in which the sample absorbed energy destructively from the CW laser, and some of the coating composition 202 evaporated from the sample producing vapor 204 during irradiation of the sample with the CW laser. Compared to the data for Example 2, the C_{abs} data for the CW laser show a decrease relative to the sample irradiated by waveform 162.

### Example 4

### Photoacoustic Spectroscopy with a Photoacoustic Spectrometer

In this example, the absorption spectrum of water vapor as a function of water concentration via the relative humidity (RH) was measured across the visible and near-IR (500 nm to 840 nm) using a photoacoustic spectrometer (PA) and a pulsed supercontinuum laser source. Measured absorption intensities and peak shapes were quantified and compared to spectra calculated using HITRAN2012 database. Experimental setup is sufficiently similar to that described in Example 2 except that sample 108 was generated directly by vapor generator 138 which was sufficiently similar to a humidity generator.

### Example 5

### Photoacoustic Spectroscopy with a Photoacoustic Spectrometer

In this example, the absorption spectrum of size- and mass-selected nigrosin aerosol was measured across the visible and near-IR (500 nm to 840 nm) using a photoacoustic spectrometer (PA) and a pulsed supercontinuum laser source. Experimental setup was sufficiently similar to that described in example 2 except that aerosol generator 136 consisted of a liquid jet cross flow atomizer producing nigrosin aerosol from a nigrosin solution. Spectra were measured as a function of aerosol size- and mass- and agree with Mie theory calculations. The broadband absorption spectrum of a flame generated soot aerosol was measured as a function of RH. The data show the broadband laser source provides probe light to measure absorption spectra of the aerosol.

### Example 6

### Photoacoustic Spectroscopy with a Photoacoustic Spectrometer

In this example, the absorption spectrum of size- and mass-selected nigrosin aerosol was measured across the visible and near-IR (500 nm to 840 nm) using a photoacoustic spectrometer (PA) and a pulsed supercontinuum laser source. Experimental setup was sufficiently similar to that described in example 2.

Photoacoustic spectroscopy (PAS) can measure the absorption of gas or aerosol-phase species in situ. PAS can use a non-resonant or resonant acoustic cavity. For a resonant acoustic cavity, the acoustic pressure generated (p̅) at the resonance frequency f₀ depends on the absorption coefficient (α_{abs}), the incident optical power (w), the resonator length (L) and volume (V) as provided in formula (1)

$$\overline{p} = \frac{γ - 1}{{β}_{p} T} \frac{QGL}{2 π {f}_{0} V} R {α}_{abs} W , \qquad ( 1 )$$

wherein T is the temperature. The terms G and R represent the dimensionless overlap integral to accounts for the shape of the resonator and the relative response factor, respectively, which we assume to be 1. The measured signal is also dependent upon the bath gas in which the measurement in taking place through the ratio of the isobaric and isochoric specific heats, given by the term γ (γ=1.4 in air). Since measurements were performed in a resonant acoustic cavity, the quality factor (Q) represented the ratio of the resonance frequency (f₀) and the half width (g) of the resonance provided in formula 2.

$$Q = \frac{{f}_{0}}{2 g} , \qquad ( 2 )$$

The speed of sound is a function of temperature and gas composition causing the resonance frequency to display a similar dependence. Acoustic resonators with high Q are achievable (>1,000) and moderate values of Q (20 to 30) are available. Values for f₀ and Δf can be determined by fitting the resonance response function as provided in formula 3

$$u + i v = \frac{i fA}{{( {f}_{0} + g )}^{2} - {f}^{2}} + B + C ( f - \overline{f} ) , \qquad ( 3 )$$

wherein u and v are the real and imaginary components of the acoustic response, A is the complex amplitude, B and C are adjusted complex background parameters and f̅ is the midpoint frequency between the highest and lowest frequency in the data set. Since many terms in formula 1 are constants, formula 1 can be simplified and rearranged to solve for α_{abs} as provided in formula 4

$${α}_{abs} = \frac{{P}_{m}}{{β}_{m}} \frac{1}{{C}_{c} {W}_{pp}} , \qquad ( 4 )$$

wherein Pₘ, βₘ and C_{c} are the microphone voltage measured at the resonant frequency, the microphone sensitivity and the cell constant. Since the acoustic response contains both real and imaginary components, phase sensitive detection was used; either a fast Fourier transformation of the measured data or a lock-in amplifier can fulfill this requirement.

Radiative transfer models for gases have been developed that can parameterize the strength of gas phase absorption based upon both temperature and pressure. The parameterization of aerosols in radiative transfer models is not as straight forward. Particle absorption can be calculated assuming either: 1) a particle size distribution, number concentration, mass density and refractive index or 2) a wavelength dependent and size independent mass-specific absorption cross section (MAC, in units of m² g⁻¹) and particle mass concentration (M, in units g m⁻³).

Photoacoustic (PA) absorption spectra across the visible and near-IR (500 nm to 850 nm) for both gas and aerosol phase species were collected. We measured absorption spectra of H₂O_{(g)} and compared the empirical spectra to that calculated with HITRAN 2012. We then measured the MAC of aerosolized nigrosin dye to show a measured dependence of MAC and spectral shape on particle size and mass for an aerosol. We quantitatively measure both gas phase and aerosol phase absorption spectra simultaneously using a broadband source.

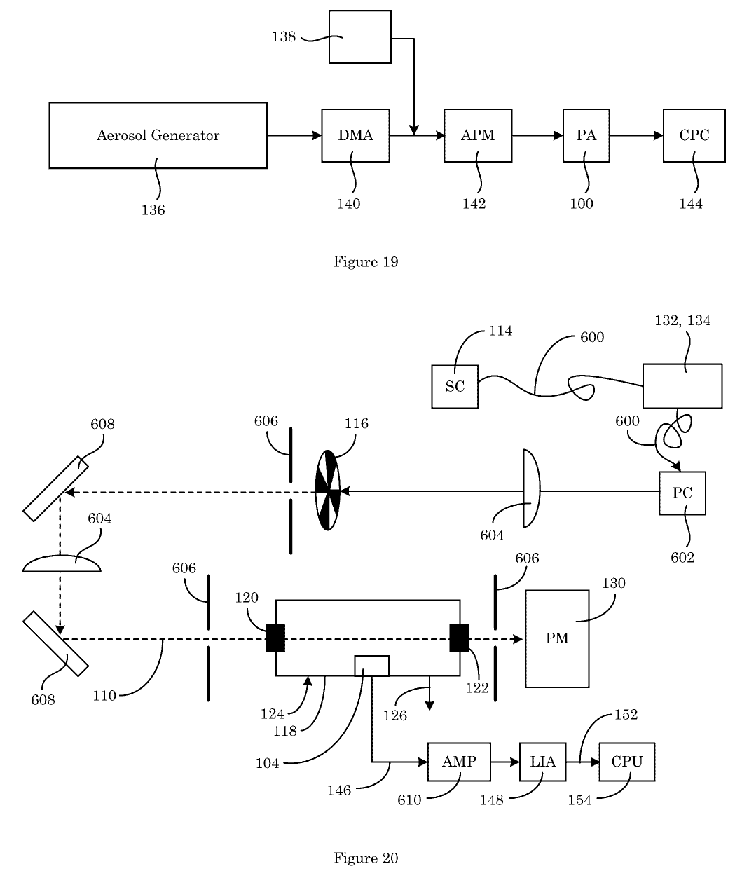

FIG. 19 shows an experimental setup for absorption measurements in which the setup includes aerosol generator 136 to provide aerosol 109, differential mobility analyzer 140 in fluid communication with aerosol generator 136 to receive aerosol 109, vapor generator 138 (VG) in fluid communication with differential mobility analyzer 140 (DMA) to impart a coating on aerosol 109 from vapor 111, and aerosol particle mass analyzer 142 (APM) in fluid communication with differential mobility analyzer 140 and vapor generator 138 to mass select aerosol 109, cavity 118 in fluid communication with aerosol particle mass analyzer 142 to receive sample 108 there from, and condensation particle counter 144 (CPC) in fluid communication with cavity 118 (PA) to receive the sample. The setup was used to determine water vapor or aerosol absorption spectra.

FIG. 200 shows a photoacoustic spectrometer that was used to measure absorption spectra. Here, the photoacoustic spectrometer included a supercontinuum laser 114 (SC) in optical communication with tunable wavelength and bandwidth filter (132, 134, TWBF) fiber optical cable 600, parabolic collimator 602 (PC), focusing lenses 604, modulator 116 (a mechanical chopper), iris 606, mirror 608, window 120 and 122, transducer 104 (a microphone), cavity 118 (an acoustic resonator), optical detector 130 (a power meter, PM), aerosol inlet 124, outlet 126, low-noise preamplifier 610 (AMP), phase sensitive detector 148 (a lock-in amplifier, LIA), and computer 154 (CPU).

Wavelength selection and amplitude modulation of the supercontinuum laser 114 (SC) (commercially available as NKT Photonics SuperK Extreme EXR-15, ≈5.5 W over 475 nm to 2.5 μm, ≈1.5 Win the spans 475 nm to 700 nm, 78 MHz repetition rate, 650 ps pulse width) was performed using tunable wavelength and bandwidth filter (132, 134, TWBF) (commercially available as NKT Photonics SuperK Varia, output 475 nm to 850 nm) and mechanical chopper 116 (commercially available as ThorLabs MC-2000 with MC 1F30 blade) driven by a function generator (not shown, commercially available as Stanford Research Systems D5345). Tunable wavelength and bandwidth filter 132, 134 provided a change in wavelength at greater than 10 nm s⁻¹. The input and output of tunable wavelength and bandwidth filter 132, 134 were fiber coupled to supercontinuum laser 114 and a protected silver reflective collimator (PC) (commercially available as ThorLabs RC04FC-P01), respectively. The laser light traveled in free space through chopper 116 and cavity 118. An iris is situated ≈25 mm behind chopper 116 and two irises were situated ≈25 mm before and after cavity 118 to remove stray light from the collimator, light diffracted by chopper 116 and light reflected by the face of power meter 130, respectively. At this aperture diameter, irises 606 remove stray light and do not affect the total power transmitted although the beam width is a function of wavelength. Filter bandwidth of bandwidth filter 134 was chosen such that the total laser power reaching cavity 118 was a minimum of 14 mW, as measured by optical detector 130 (commercially available as Newport, model 2931-C with 91D-SL-OD3 detector) situated at an exit of cavity 118. For wavelengths where the power was greater than 14 mW but the bandwidth would have been less than 10 nm, the bandwidth was set to 10 nm.

Microphone signal 146 was conditioned with low noise preamplifier 610 (commercially available as Stanford Research Systems, model SR560) set to 6 dB/octave roll-off below 300 Hz and above 3000 Hz. Microphone signal 146 was passed to lock-in amplifier 148 (commercially available as Stanford Research Systems, model SR830, time constant τ=10 ms). In-phase (x) and quadrature (y) components of lock-in amplifier 148 and analog output of power meter 130 were sampled at 100 kHz for 1 s using a data acquisition system (commercially available as National Instruments BNC-2120 and PCI-6281 data acquisition boards) and analyzed using software (commercially available as LabView 8.6 virtual instruments) that included custom written source code. A power spectrum of data from power meter 130 was calculated, and the RMS voltage at the acoustic frequency AF (i.e., modulation frequency) of chopper 116 (V_{RMS}) was retained for further analysis. The RMS voltage was multiplied by a maximum power allowed at each wavelength and the square root of eight (i.e., √8) to obtain a peak-to-peak laser power (Wₚₚ). Voltages from lock-in amplifier 148 were averaged. Absorption coefficients were determined from formula 5

$${α}_{abs} = \frac{\sqrt{{( x - {x}_{0} )}^{2} + {( y - {y}_{0} )}^{2}}}{{C}_{c} {β}_{m} {W}_{pp}} , \qquad ( 5 )$$

wherein the pairs x and y and x₀ and y₀ are voltages from lock-in amplifier 148 while aerosols were measured or signal from lock-in amplifier 148 with laser 114 off, respectively. Terms C_{c} and βₘ respectively represented a cell constant of cavity 118 and sensitivity of microphone 104. Here, C_{c}βₘ=0.187 V m W⁻¹. In total, 30 one-second samples were analyzed and averaged. The 30 s averages were binned and averaged to 5 min. The limit of detection (LOD) at this averaging time (three times the background deviation) was calculated using an Allan variance and determined to be 9.6×10⁻⁸ W m⁻¹ independent of wavelength. Wavelength regions were randomized at the start of each experiment.

Water vapor absorption spectra were acquired as follows. Moist air was generated using a vapor generator 138 (commercially available as InstruQuest, Inc. HumiSys HF) at multiple relative humidity values. The absorption spectrum was measured using the PA at 18 wavelength sections spanning 625 nm to 840 nm with a higher concentration of points around 725 nm and 825 nm to resolve the water absorption bands. The relative humidity (RH) of the air stream was monitored by an RH and temperature sensor (commercially available as Air Chip Technology HygroClip2) that was calibrated using a chilled mirror hygrometer (commercially available as Edgetech Instruments DewMaster). Absorption spectra were calculated using HITRAN2012 with a resolution of 0.05 cm⁻¹.

Nigrosin generation and conditioning were performed as follows. Nigrosin (commercially available as Sigma Aldrich, water soluble form) aerosols were generated from 2 mg mL⁻¹ solution using a liquid jet cross flow atomizer (commercially available as TSI 3076, 30 psig). A portion of the generated flow (0.5 L min⁻¹) was sampled for conditioning and measurement while the excess flow (≈1.5 L min⁻¹) was exhausted to a fume hood. Aerosols were conditioned by passing the stream through a large diameter Nafion dryer (commercially available as PermaPure MD-700-48F-3), a pair of diffusion dryers (commercially available as TSI 3062) and a tube furnace (commercially available as Lindberg-Blue Mini-Mite) at 150° C. The relative humidity (RH) of the air stream exiting the dryers was monitored using an RH and temperature sensor and was less than 10±2% RH prior to optical measurement. Desiccant was replaced when the air stream was greater than 15% RH. The conditioned aerosol from this aerosol generation scheme 136 was size-selected and mass-selected using a differential mobility analyzer 140 (commercially available as TSI 3080 Electrostatic classifier with 3081L column) and an aerosol particle mass analyzer 142 (commercially available as Kanomax 3601). Particle number concentration was measured using a condensation particle counter 144 (commercially available as TSI 3775). Coupled to the PA absorption measurement, the observables measured by the APM and CPC of mass (mₚ) and number density (N) respectively provided calculation of aerosol MAC provided by formula 6

$$MAC = \frac{{α}_{abs}}{{Nm}_{p}} = \frac{{C}_{abs}}{{m}_{p}} , \qquad ( 6 )$$

wherein C_{abs} is the absorption cross section. The combination of differential mobility analyzer 140 and aerosol particle mass analyzer 142 provided isolation of +1 charged particle of interest.

UV-Vis absorption spectra of 5×10⁻³ mg mL⁻¹ nigrosin solution was measured from 500 nm to 850 nm with a 4 nm slit width using a spectrophotometer (commercially available as Perkin-Elmer Lambda Bio 20).

Soot was generated using a Santoro diffusion flame with ethylene fuel. Soot was aspirated into a dry, HEPA-filtered carrier air stream via a sampling tube located 5 cm above the centerline of the burner. No conditioning of the soot was performed prior to size selection by the differential mobility analyzer 140. Flows from the vapor generator 138 and differential mobility analyzer 140 were merged prior to the aerosol particle mass analyzer 142 for the measurement of soot at elevated humidity.

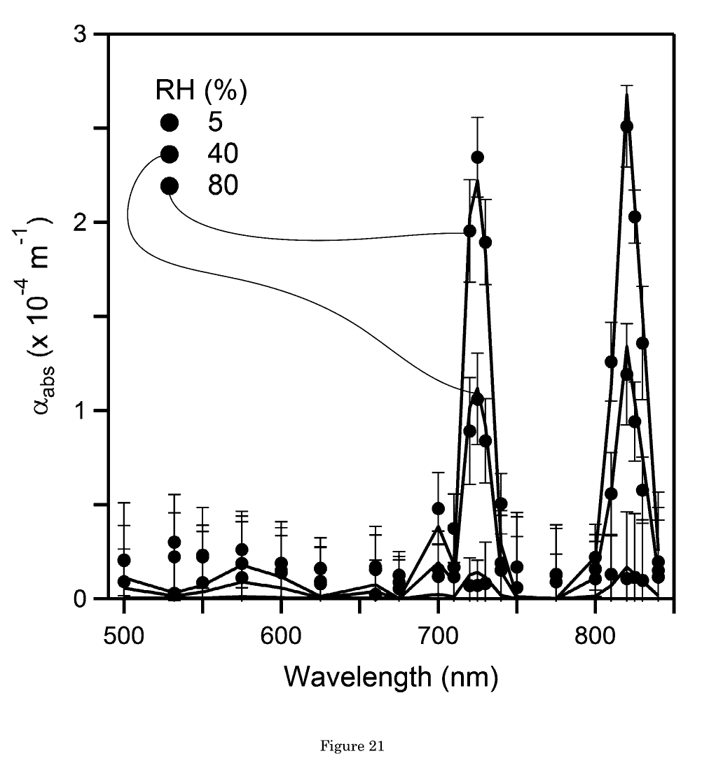

Water vapor absorption spectrum was acquired as follows. The water vapor absorption spectrum from 625 nm to 840 nm is shown in FIG. 21 for a relative humidity of 5% (black), 40% (red), and 80% (green). Solid lines corresponded to calculated absorption spectrum from HITRAN for the specified bandwidths. Error bars corresponded to 2σ measurement uncertainty. The absorption spectrum of H₂O_{(g)} was calculated using Voigt profiles based on calculated collisional and Doppler widths determined from HITRAN 2012 line parameters at 10% RH at 296 K with a resolution of 0.05 cm⁻¹; this corresponded to a nominal H₂O_{(g)} mole fraction of 2.76×10⁻³ in 1 atm of air. To account for the bandwidth and power density of the laser, absorption coefficients were calculated as provided in formula 7

$${α}_{abs} = \frac{\int S ( λ ) P ( λ ) d λ}{\int P ( λ ) d λ} , \qquad ( 7 )$$

wherein S(λ), P(λ), and dλ were the signal intensity and power at a given wavelength (λ) and the spacing between sequential wavelengths, respectively. Power density was measured for wavelength regions greater than or equal to 600 nm using an optical spectrum analyzer. Across the set of wavelengths where the measured absorption was above the limit of detection, the average absolute value of the relative error was less than 16%. To account non-linearity in microphone 104 response as a function of H₂O vapor, absorption was measured at the peak wavelengths of 725 and 820 nm.

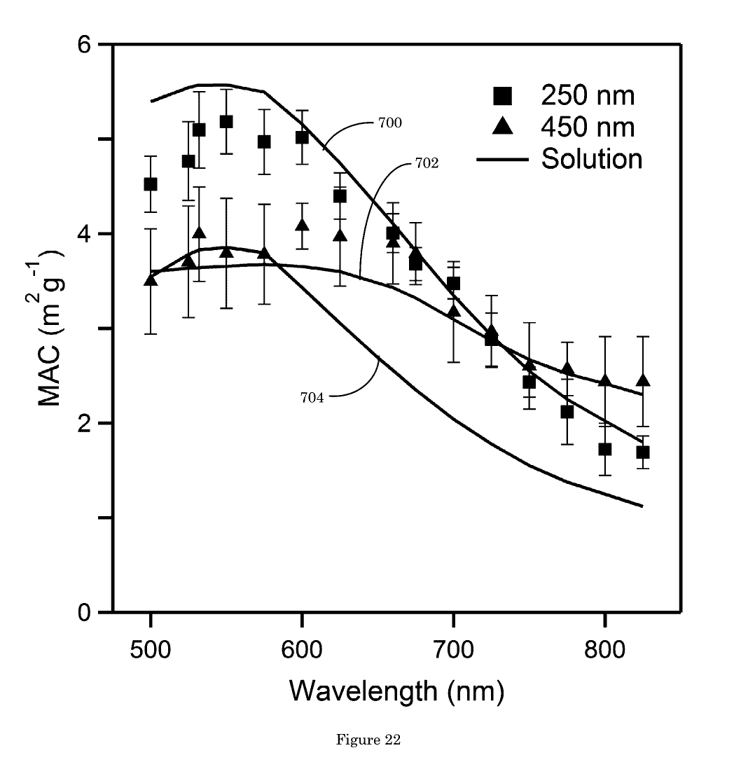

Nigrosin aerosol mass-specific absorption spectrum was acquired as follows. Nigrosin absorbs across the visible region with a well-defined peak (solution absorption peak at ≈550 nm). Using the broadband source with sufficient resolution allows for relatively small variations in the spectral shape to be resolved. By selecting aerosol with known size and mass, the data can be quantitatively compared to Mie theory. The measured nigrosin aerosol mass specific absorption spectrum for two mobility diameter and mass combinations (250 nm and 1.04×10⁻¹⁴ g; 450 nm and 5.80×10⁻¹⁴ g) are shown respectively in FIG. 22 as squares and triangles. Curve 700 and curve 702 correspond to MAC values calculated using Mie theory and a particle density of 1.34 g cm⁻³, based on an average from mass distribution fits. Curve 704 corresponded to measured mass-specific absorption spectrum of a 5.0×10⁻³ mg mL⁻¹ solution. Error bars in MAC represented 2σ measurement uncertainty, as calculated from propagation of uncertainty in the measured absorption, laser power, mass and number concentration. A total of 16 wavelength regions were studied and spanned from 500 nm to 825 nm.

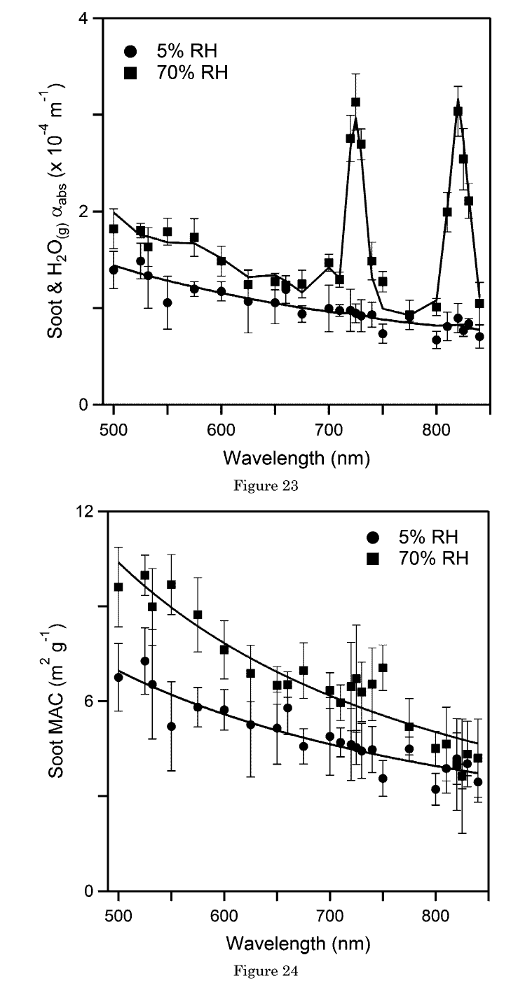

Soot and water vapor absorption spectrum was acquired as follows. An absorption spectrum of soot generated from a Santoro diffusion flame was acquired. Data were collected at both at low (10%) and elevated (70%) RH as shown in FIG. 23 as circles and squares, respectively. The total measured absorption contained contributions from both the soot and H₂O_{(g)} is provided in formula 8.

α_{abs}=αₛₒₒₜ+α_{H}_{₂}_{O}_{_{(g)}} (8),

The absorption by water vapor was calculated using the power-weighted absorption coefficients determined from HITRAN is provided by formula 9.

$${α}_{{H}_{2} {O}_{( g )}} = \frac{RH ( \% )}{10 \%} * {α}_{{H}_{2} {O}_{( g )}} ( 10 \% ) , \qquad ( 9 )$$

The absorption contribution from the aerosol was simplified by assuming the absorption was provided by a single power law expression, the absorption Angstrom exponent (AAE) was provided as formula 10.

$${MAC}_{λ} = {{k}_{0} ( \frac{λ}{500 nm} )}^{- AAE} , \qquad ( 10 )$$

Since particle mass and number concentrations were known, absorption coefficient was provided by formula 11.

$${α}_{abs} = N * {m}_{p} * {{k}_{0} ( \frac{λ}{500 nm} )}^{- AAE} + \frac{RH ( \% )}{10 \%} * {α}_{{H}_{2} {O}_{( g )}} ( 10 \% ) , \qquad ( 11 )$$

The fitting procedure was applied for each RH in FIG. 23 as shown by the solid curves. From the fitted data, the soot absorption contribution from the total absorption spectrum was used to calculate the soot MAC under both conditions and eliminated contribution to mass from water adsorption on soot. These data are shown in FIG. 24. The absolute RH calculated from the fit, MAC at λ=500 nm and the AAE are shown in the Table, wherein uncertainties were 2σ.

TABLE

| RHₛₑₜₚₒᵢₙₜ | RH_{calc} | k₀ | |
|---|---|---|---|
| (%) | (%) | (m² g⁻¹) | AAE |
| 5 | 1 ± 4 | 7.0 ± 0.4 | 1.2 ± 0.4 |
| 70 | 68 ± 8 | 10.4 ± 0.7 | 1.6 ± 0.3 |

The measured data show that MAC and AAE of the soot were a function of RH, with higher values measured at higher RH. MAC enhanced by 1.5 at 500 nm; values are within 2σ. Measured enhancement was attributed to a thin surface coating of water. The magnitude of an enhancement what was a function of the wavelength dependent dry particle absorption cross section.

Experiments presented used an ultrafast, pulsed laser source 114 (78 MHz repetition rate and 650 ps pulse duration, respectively) to circumvent coating vaporization as particle thermal relaxation was faster than the evaporation rate of water for soot. In contrast, continuous-wave (CW) lasers heat and cool at the acoustic period that can cause evaporation and reduction of an apparent cross section.

The effect of utilizing an ultrafast pulsed laser source was compared to using a CW source at identical time-averaged laser power and wavelength (660 nm). Absorption cross sections were measured at 5% and 70% RH. The measured absorption cross sections were within measurement uncertainty at 5% RH, and the pulsed laser source was enhanced by 21% at 70% RH. The data from the ultrafast pulsed laser source show that pulse duration or duty cycle negate signal dampening in PAS for humidified samples.

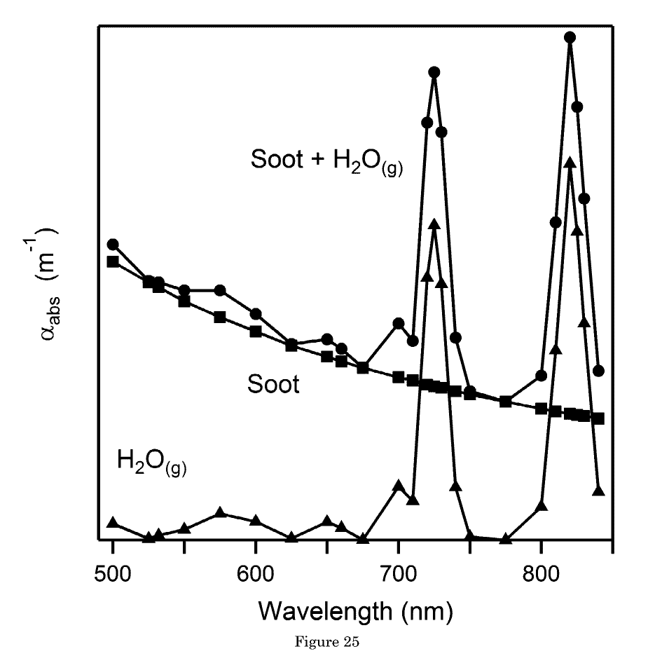

FIG. 25 shows a graph of absorption coefficient versus wavelength is a summary of data presented in this Example. Accordingly, PAS using supercontinuum laser 114 quantitatively measured the absorption spectrum of gas and aerosol phase species across the visible and near-IR and decoupled each phase contribution to the total signal and provided measurement of soot absorption enhancement at high RH.

While one or more embodiments have been shown and described, modifications and substitutions may be made thereto without departing from the spirit and scope of the invention. Accordingly, it is to be understood that the present invention has been described by way of illustrations and not limitation. Embodiments herein can be used independently or can be combined.

Reference throughout this specification to “one embodiment,” “particular embodiment,” “certain embodiment,” “an embodiment,” or the like means that a particular feature, structure, or characteristic described in connection with the embodiment is included in at least one embodiment. Thus, appearances of these phrases (e.g., “in one embodiment” or “in an embodiment”) throughout this specification are not necessarily all referring to the same embodiment, but may. Furthermore, particular features, structures, or characteristics may be combined in any suitable manner, as would be apparent to one of ordinary skill in the art from this disclosure, in one or more embodiments.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix “(s)” as used herein is intended to include both the singular and the plural of the term that it modifies, thereby including at least one of that term (e.g., the colorant(s) includes at least one colorants). “Optional” or “optionally” means that the subsequently described event or circumstance can or cannot occur, and that the description includes instances where the event occurs and instances where it does not. As used herein, “combination” is inclusive of blends, mixtures, alloys, reaction products, and the like.

As used herein, “a combination thereof” refers to a combination comprising at least one of the named constituents, components, compounds, or elements, optionally together with one or more of the same class of constituents, components, compounds, or elements.

All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. “Or” means “and/or.” Further, the conjunction “or” is used to link objects of a list or alternatives and is not disjunctive; rather the elements can be used separately or can be combined together under appropriate circumstances. It should further be noted that the terms “first,” “second,” “primary,” “secondary,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

What is claimed is:

1. A photoacoustic spectrometer comprising:
a light source to irradiate nondestructively a sample and to provide a probe light comprising:
an acoustic frequency; and
a high-frequency; and
a transducer to detect a photoacoustic signal, the photoacoustic signal produced from the sample in response to absorption of the probe light by the sample.

2. The photoacoustic spectrometer of claim 1, further comprising a cavity to receive the sample and the probe light.

3. The photoacoustic spectrometer of claim 2, wherein the cavity comprises a resonant cavity.

4. The photoacoustic spectrometer of claim 2, wherein the cavity comprises a non-resonant cavity.

5. The photoacoustic spectrometer of claim 2, wherein the cavity comprises a first window to transmit the probe light into the cavity.

6. The photoacoustic spectrometer of claim 5, wherein the cavity comprises a second window to transmit the probe light out of the cavity.

7. The photoacoustic spectrometer of claim 5, wherein the cavity comprises an inlet to communicate the sample into the cavity.

8. The photoacoustic spectrometer of claim 7, wherein the cavity comprises an outlet to communicate the sample out of the cavity.

9. The photoacoustic spectrometer of claim 1, further comprising an optical detector to detect the probe light.

10. The photoacoustic spectrometer of claim 9, wherein the optical detector comprises a power meter, a photodiode, or a combination comprising at least one of the foregoing.

11. The photoacoustic spectrometer of claim 1, wherein the transducer comprises a microphone.

12. The photoacoustic spectrometer of claim 1, wherein the light source comprises:
a first light source to produce a first light comprising the high-frequency; and
a modulator to receive the first light and to modulate the first light at the acoustic frequency to produce the probe light.

13. The photoacoustic spectrometer of claim 12, wherein the first light source comprises a supercontinuum laser.

14. The photoacoustic spectrometer of claim 13, further comprising:
a wavelength filter to select a wavelength of the first light; and
a bandwidth filter to filter a bandwidth of the first light.

15. The photoacoustic spectrometer of claim 12, wherein the modulator comprises an optical modulator, a mechanical modulator, or a combination comprising at least one of the foregoing.

16. The photoacoustic spectrometer of claim 12, wherein the high-frequency comprises a frequency greater than or equal to 50 MHz; and
the first light comprises:
a pulse width less than or equal to 5 nanoseconds; and
a duty cycle less than or equal to 50%.

17. The photoacoustic spectrometer of claim 16, wherein the acoustic frequency comprises a frequency that is less than the high-frequency; and
a pulse width of the modulation of the modulator subjected to the first light is from 25 microseconds to 25 milliseconds.

18. A photoacoustic spectrometer comprising:
a light source comprising:
a supercontinuum laser to produce a first light comprising a high-frequency;
a tunable wavelength filter to select a wavelength of the first light;
a bandwidth filter to select a bandwidth of the first light;
a modulator to receive the first light and to modulate the first light at an acoustic frequency to produce a probe light comprising:
the acoustic frequency; and
the high-frequency,
the light source to irradiate nondestructively a sample with the probe light;
a cavity to receive the sample and the probe light and comprising:
a first window to transmit the probe light into the cavity; and
a second window to transmit the probe light out of the cavity;
a transducer to detect a photoacoustic signal produced from the sample in response to absorption of the probe light by the sample; and
an optical detector to detect the probe light.

19. A process for performing photoacoustic spectroscopy, the process comprising:
producing a first light comprising a high-frequency;
modulating the first light at an acoustic frequency to produce a probe light comprising:
the acoustic frequency; and
the high-frequency;
communicating the probe light to a cavity;
providing a sample to the cavity;
irradiating nondestructively the sample with the probe light;
producing a photoacoustic signal by the sample in response to absorption of the probe light by the sample; and
detecting the photoacoustic signal to perform photoacoustic spectroscopy on the sample.

20. The process of claim 19, further comprising:
detecting the probe light; and
producing a reference signal based on detected probe light;
wherein detecting the photoacoustic signal comprises phase locking to the reference signal.
